(19) United States
(12) Patent Application Publication
(10) Pub. No.: US 2026/0208658 A1
(43) Pub. Date: Jul. 23, 2026

(54) VEHICLE LIGHTING SYSTEM COMPRISING MEANS FOR EMITTING A LUMINOUS SIGNAL CODED AT VERY HIGH FREQUENCY

(71) Applicant: VALEO VISION, Bobigny (FR)

(72) Inventors: Matheo GOURDON, Bobigny (FR); Mickael MIMOUN, Bobigny (FR); Pierre RENAUD, Bobigny (FR); Geoffrey PIQUARD, Bobigny (FR); Hafid EL IDRISSI, Bobigny (FR); Sidahmed BEDDAR, Bobigny (FR)

(73) Assignee: VALEO VISION, Bobigny (FR)

(21) Appl. No.: 19/137,548

(22) PCT Filed: Dec. 15, 2023
(86) PCT No.: PCT/EP2023/086220

§ 371 Date: Jun. 10, 2025

(30) Foreign Application Priority Data
Dec. 16, 2022 (FR) FR2213704

(51) Int. Cl. B60Q 1/00; G01S 17/08; G01S 17/88

(52) U.S. Cl. CPC B60Q 1/0023; G01S 17/08; G01S 17/88

(57) ABSTRACT

The present invention relates to a lighting system for a vehicle. The lighting system includes a front left lighting device and a front right lighting device each able to project a lighting beam, means for emitting a high-frequency coded luminous signal outside the vehicle, and means for receiving such a luminous signal. The lighting system includes a luminous device arranged on the vehicle between the lighting devices, obstacle detection means, and means for decoding a luminous signal received by the luminous device, able to provide at least one value representing a time shift between the luminous signal received by the luminous device and a luminous signal sent by the luminous device to the obstacle detection means.

### TECHNICAL FIELD

The present invention relates to the automotive and opto-electronic fields. More specifically, it relates to a lighting system for a vehicle.

### BACKGROUND OF THE INVENTION

In recent vehicles, light-emitting diode assemblies are commonly used to produce the external lighting devices, such as the headlamps or the indicator lights. These assemblies of diodes provide enough luminous intensity to provide the regulatory lighting functions and to provide an advantageous power-to-consumption ratio.

These assemblies of diodes also allow luminous signatures to be generated that are specific to each make of vehicle and are considered to be future means for communicating between vehicles or with the road infrastructures, using optical communication technology, such as VLC (Visible Light Communication), for example.

The inventors have discovered that other applications can be contemplated, such as an obstacle detection application, by increasing the bandwidth of the light-emitting diodes, either by equalization techniques, or by using diodes that are smaller than 300 micrometers, or by combining these techniques. This application can require the use of a specific type of control unit (also called “driver”) such as a high-speed control unit (or “high-speed driver”) or a laser control unit (or “laser driver”).

Indeed, the bandwidth of a conventional one millimeter-sided light-emitting diode is approximately 5 MHz (MegaHertz), and is therefore sufficient to allow luminous communication between vehicles or between a vehicle and a road infrastructure. However, this bandwidth is not adapted to obstacle detection type applications. Such an application is nevertheless optically carried out in some vehicles using LiDAR (“Light Detection And Ranging”) technology based on laser sensors for analyzing the reflected signal over a bandwidth of the order of several tens of MegaHertz, or even of a few hundred MegaHertz. However, LiDAR systems on-board vehicles are very expensive.

### SUMMARY OF THE INVENTION

The inventors have therefore enabled this expensive obstacle detection technology for vehicles to be replaced with light-emitting diode-based vehicle lighting devices applying an obstacle detection function, in addition to regulatory lighting functions.

However, the lighting devices are located on the sides of the front face of the vehicle, and the regulations stipulate having a distance between these lighting devices. As a result, a non-illuminated area exists in front of the vehicle between these lighting devices. This constraint therefore does not allow obstacles located in the vicinity of the vehicle and in front of the vehicle to be detected with the technology developed by the inventors, which notably does not allow it to be used by a parking assistance system of the vehicle.

The aim of the present invention is to at least partly overcome the disadvantages of the prior art by providing a lighting system for a vehicle based on light-emitting diodes, for detecting obstacles in a parking situation, and an associated vehicle.

To this end, the present invention proposes a lighting system for a vehicle, the lighting system comprising an optical assembly comprising a front left lighting device and a front right lighting device each able to project a lighting beam, the optical assembly further comprising means for emitting a high-frequency coded luminous signal outside the vehicle, comprising photonic emitters, and means for receiving such a luminous signal arriving from outside the vehicle, comprising photonic receivers,
characterized in that the optical assembly further comprises a luminous device intended to be arranged on the vehicle between the lighting devices, the luminous device comprising at least one portion of the set of photonic emitters and at least one portion of the set of photonic receivers, and in that the lighting system further comprises obstacle detection means, and means for decoding a luminous signal received by one of the photonic receivers of the luminous device, able to provide at least one value representing a time shift between, on the one hand, the luminous signal received by the photonic receiver of the luminous device and, on the other hand, a luminous signal sent by at least one of the photonic emitters of the luminous device to the obstacle detection means.

The lighting beams emitted by the lighting devices are, for example, regulatory lighting lights, such as high or low beam lights. However, they do not allow light to be emitted in an area close to the vehicle located in front of the vehicle between the two lighting devices. The luminous device of the lighting system according to the invention comprises light-emitting diodes for illuminating this area, and is coupled to the obstacle detection means, at least partly implemented in a computer of the vehicle. It therefore allows obstacles located in this area to be avoided.

In one embodiment, the photonic emitters are configured to emit wavelengths in the visible spectrum. By way of an example, the photonic emitters can be light-emitting diodes.

In one embodiment, the photonic emitters and the photonic receivers of the luminous device are not directional, i.e., their emission or, respectively, reception surfaces are fixedly mounted parallel to the front face of the vehicle, no mirror or other luminous device in the vehicle changes the emission direction of the luminous signals emitted or received by the luminous device. Indeed, the main function of the luminous device is obstacle detection, which is easier to implement with emitters and receivers oriented in the same way.

According to an advantageous feature of the lighting system according to the invention, at least one of the lighting devices comprises another portion of the set of photonic emitters of the emission means and another portion of the set of photonic receivers of the reception means. Preferably, the two lighting devices of the optical assembly comprise photonic emitters and photonic receivers. The lighting devices are thus also involved in an obstacle communication and/or detection function, managed from a computer of the vehicle.

In one embodiment, the photonic emitters of the at least one lighting device are of the same type as the photonic emitters of the luminous device. This allows the processing of the signals to be simplified, which signals are to be transferred to the lighting devices and to the luminous device in order to implement the obstacle detection function. Indeed, there is no need to convert signals between different formats and/or different in order to adapt to the type of photonic emitter. By way of an example, the photonic emitters of at least one of the lighting devices are configured to emit wavelengths in the visible spectrum. Preferably, they are light-emitting diodes.

Additionally or alternatively, the photonic receivers of at least one of the lighting devices are the same type as the photonic receivers of the luminous device. Thus, in the proposed lighting system, the lighting devices and the luminous device are designed in the same manner in terms of the obstacle detection aspect. Of course, this does not prevent each of these devices from having additional configurations for carrying out another function, for example, the lighting function for the lighting devices and the luminous decoration function for the luminous device.

The decoding means are able, for example, to decode a luminous signal received by one of the photonic receivers of the lighting device, and to provide at least one value representing a time shift between the luminous signal received by the photonic receiver of the lighting device and a luminous signal sent by at least one of the photonic emitters of the lighting device to the obstacle detection means. By virtue of the invention, obstacle detection is possible over the entire area in front of the vehicle using the light-emitting diodes of the lighting devices and of the luminous device.

Advantageously, the luminous device is also able to implement a display or signaling function. The luminous device is able, for example, to apply a communication function by displaying, or by projecting signs on the roadway, or even by VLC communication.

According to one advantageous feature of the invention, the emission means comprise means for coding a high-frequency signal intended to be transmitted by photonic emitters of the luminous device, at a frequency ranging between 5 and 200 MHz. Such a frequency allows the obstacle detection function to be implemented. Preferably, the frequency of the luminous signal transmitted by the emission means nevertheless ranges between 30 and 150 MHz.

According to another advantageous feature of the invention, the emission means are configured to send the photonic emitters of the lighting device an electrical signal coding a first sequence of square waves, and to send the photonic emitters of the luminous device an electrical signal coding a second sequence of square waves. The first sequence of square waves is preferably different from the second sequence of square waves. Thus, any interference is avoided between the signals sent by the lighting devices and the signals sent by the lighting device for obstacle detection. As a variant, the first sequence of square waves is identical to the second sequence of square waves. In both cases, whether the first sequence is identical or different from the second sequence, in an alternative embodiment limiting this interference:
the electrical signal coding the first sequence of square waves has less electrical power than the electrical power of the electrical signal coding the second sequence of square waves; and/or
the first sequence of square waves is sent at a frequency that differs from a sending frequency of the second sequence of square waves.

Preferably, the photonic emitters of the lighting devices emit the same luminous signal for obstacle detection. Indeed, the risk of interference between the lighting devices is low at a short distance from the vehicle. In addition, if the distance to the obstacle is quite large, one of the lighting devices receiving a luminous signal emitted by the other lighting device will provide an accurate enough analysis of the distance to the obstacle.

In one embodiment of the invention, in the lighting system according to the invention, the decoding means comprise means for thresholding a luminous signal received by one of the photonic receivers of the lighting system, providing a thresholded luminous signal, and means for correlating the thresholded luminous signal with a luminous signal sent by at least one of the photonic emitters of the lighting system, with the correlation means providing a value representing a time shift between the thresholded luminous signal and the luminous signal sent by the photonic emitter of the lighting system, and the obstacle detection means comprise means for converting the representative value originating from the correlation means into a distance from an obstacle. The thresholding means notably allow any luminous components due to sunlight to be eliminated.

The invention also relates to a vehicle comprising a lighting system according to the invention, wherein the front left lighting device is arranged on a front left portion of the vehicle, the front right lighting device is arranged on a front right portion of the vehicle, and the luminous device is arranged on a front face of the vehicle between the front left lighting device and the front right lighting device. Thus, the lighting system as proposed benefits from the space available on the front face for installing a luminous device participating in obstacle detection at the front of the vehicle. The luminous device and the front right and front left lighting devices allow the entire front scene of the vehicle to be covered, thereby enhancing the driving safety of the vehicle.

In one embodiment of the invention, the emission surface of the photonic emitters of the luminous device and the reception surface of the photonic receivers of the luminous device are fixedly mounted parallel to the front face of the vehicle. This is a simple and efficient arrangement that is suitable for the position of the luminous device on the front face of the vehicle.

In one embodiment, the luminous device is arranged at least partially downwardly offset from the lighting devices. In this case, the term “downwardly” is defined relative to the vertical direction. It is thus possible for the luminous device to provide obstacle detection at a lower level than that of the lighting devices. Consequently, the proposed lighting system not only allows the width of the scene in front of the vehicle to be covered but also allows the height, or different levels of the scene, to be covered. In this case, the width corresponds to the horizontal lateral dimension of the vehicle and the height corresponds to the vertical dimension of the vehicle.

### BRIEF DESCRIPTION OF DRAWINGS

Further features and advantages of the invention will become more clearly apparent from the following description, on the one hand, and from several embodiments, on the other hand, which are provided by way of a non-limiting indication with reference to the appended schematic drawings, in which:

FIG. 1 shows a vehicle according to the invention provided with a lighting system according to the invention, in a first embodiment of the invention; and

FIG. 2 schematically shows the lighting system of FIG. 1, used for detecting an obstacle, in greater detail.

### DETAILED DESCRIPTION OF THE INVENTION

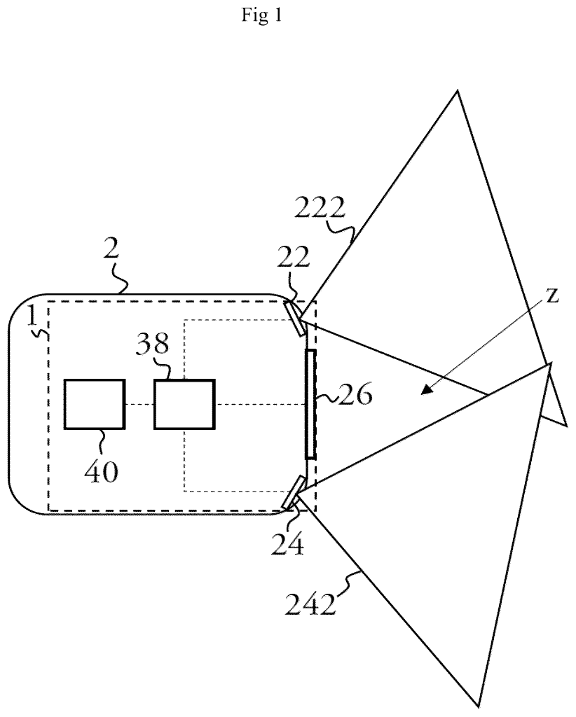

According to one embodiment of the invention, shown in FIG. 1, a vehicle 2 according to the invention comprises a lighting system 1. The lighting system 1 comprises an optical assembly. The optical assembly comprises a front left lighting device 22, arranged on a left-hand end of the front face of the vehicle 2, a front right lighting device 24 arranged on a right-hand end of the front face of the vehicle 2, and a luminous device 26 arranged on the front face of the vehicle 2, between the front left lighting device 22 and the front right lighting device 24.

The front left lighting device 22 is able to project a regulatory lighting beam 222, for example, a high beam or a low beam. Similarly, the front right lighting device 24 is able to project a regulatory lighting beam 242, for example, a high beam or a low beam.

The regulatory lighting beams 222 and 242 generated by the front left 22 and front right 24 lighting devices leave a non-illuminated area z at the front of the vehicle 2. The luminous device 26 comprises light-emitting diodes able to illuminate this area z. The luminous device 26 is connected to a computer of the vehicle by a computer bus (commonly called CAN (“Controller Access Network”) bus), and acts as means for displaying messages by the computer. These messages are intended for pedestrians or other vehicles, for example. The luminous device 26 optionally also acts as VLC communication means. The front left 22 and front right 24 lighting devices are also able to be used by the computer as VLC communication means.

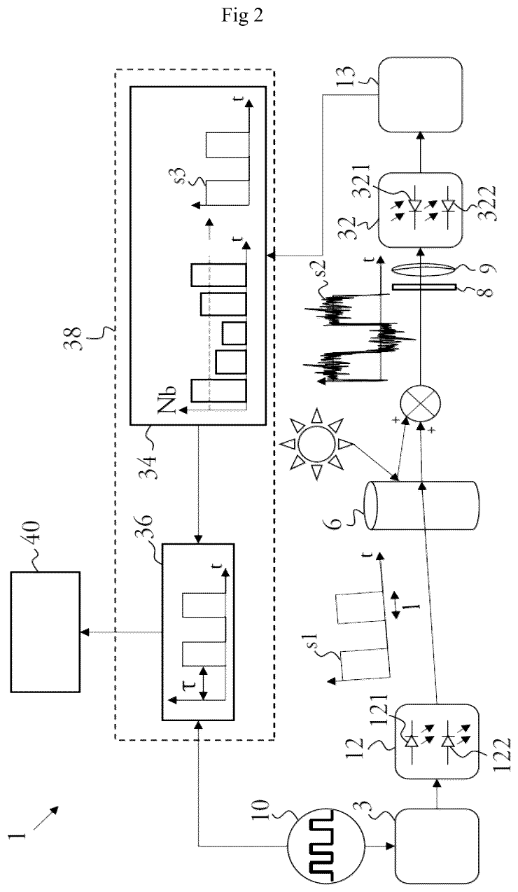

The devices 22, 24, 26 of the optical assembly of the lighting system 1 according to the invention each comprise a plurality 12 (shown in FIG. 2) of photonic emitters, which are, in this embodiment of the invention, blue light light-emitting diodes able to emit white light, for example, the light-emitting diodes 121, 122 in FIG. 2.

The light-emitting diodes 121, 122 include, for example, a layer of Indium Gallium Nitride (InGaN), onto which a layer of phosphor is deposited. Thus, they are adapted to produce a high beam or low beam type lighting beam. The light-emitting diodes 121, 122 of the luminous device 26, however, optionally only emit blue light, in an alternative embodiment where the luminous device 26 is not used for displaying or signaling.

Similarly, the devices 22, 24, 26 of the optical assembly of the lighting system 1 according to the invention each comprise a plurality 32 (shown in FIG. 2) of photonic receivers, which are, in this embodiment of the invention, photodiodes, for example, the photodiodes 321, 322 in FIG. 2. Of course, FIG. 2 only shows two light-emitting diodes and two photodiodes for the sake of simplification, with the devices 22, 24, 26 actually comprising many more diodes and photodiodes.

The diodes 121, 122 of the devices 22, 24, 26 of the optical assembly form part of means for emitting a high-frequency coded luminous signal s1 (shown in FIG. 2) outside the vehicle 2. Similarly, the photodiodes 321, 322 form part of means 32 for receiving such a luminous signal arriving from outside the vehicle 2.

Indeed, in this embodiment of the invention, the luminous device 26 and the front left 22 and front right 24 lighting devices are used by obstacle detection means 40 at least partly implemented in software form in a computer of the vehicle 2.

More specifically, the devices 22, 24, 26 of the optical assembly are connected by the computer bus of the vehicle 2 to means 38 for decoding the luminous signals received by the photodiodes 321, 322, with these decoding means 38 communicating with the detection means 40 via the computer bus.

The way the lighting system 1 allows an obstacle 6 to be detected will now be described with reference to FIG. 2. For the sake of simplification, this description is limited to obstacle detection using the light-emitting diodes 121, 122 and the photodiodes 321, 322 of the luminous device 26, with the use of the diodes and photodiodes of the front left 22 and front right 24 lighting devices for detecting an obstacle occurring in the same way. In addition, the emission and reception means of the lighting system 1 specific to the lighting devices 22, 24 are similar to the emission and reception means of the lighting system 1 specific to the luminous device 26.

The emission means of the lighting system 1 specific to the lighting device 26 comprise, in addition to the plurality 12 of light-emitting diodes, a source 10 of square wave voltage electrical signals and an electronic control device 3 for controlling these light-emitting diodes, connected at the input to the signal source 10 and at the output to the light-emitting diodes 121, 122 of the luminous device 26. To send the luminous signal s1, the source 10 provides a square wave signal, with the width 1 of the square waves being approximately 10 ns (nanoseconds) and the frequency of the signal being 50 MHz. To allow this signal with such a high frequency level to be transmitted, the electronic control device 3 comprises, for example, a pre-equalization stage, optionally associated with an amplifier stage. Instead or in addition, the light-emitting diodes 121, 122 are selected so as to be smaller than 300 micrometers so as to naturally have a cut-off frequency of more than 50 MHz. Preferably, the light-emitting diodes 121, 122 of the luminous device 26 are produced in the same substrate matrix, disposed parallel to the front face of the vehicle. The light-emitting diodes 121, 122 of the luminous device 26 can be activated individually or in fairly refined groups in order to allow characters to be displayed by the luminous device 26.

In addition, the electronic control device 3 comprises, in a known manner, a “bias-tee” device allowing a DC voltage to be injected into the signal originating from the signal source 10, optionally amplified, before applying the sum of this DC voltage and the square-wave signal originating from the signal source 10 to the terminals of the diodes 121, 122. Applying the DC voltage allows the diodes 121, 122 to be biased, thereby allowing them to emit the luminous signal s1.

The emission means specific to the luminous device 26 allow the luminous signal 5 to be sent at a frequency of 50 MHz and at a power such that its reflection on the obstacle 6 yields a reflected luminous signal s2 with enough luminous power to be picked up by photodiodes 321, 322 of the plurality 32 of photodiodes of the luminous device 26.

The reception means of the lighting system 1 specific to the luminous device 26 comprise, in addition to the photodiodes 321, 322, a blue light filter 8 for filtering the light of the reflected luminous signal s2 so as to only allow through the blue component of this light, and a lens 9 focusing this component toward the photodiodes 321, 322. The blue light emitted by the diodes 121, 122 actually has greater luminous intensity than the intensity of sunlight and its analysis therefore allows the reflected luminous signal s2 to be more easily distinguished from the external light pollution in the process of decoding this reflected luminous signal s2.

The luminous signal s1 sent by the diodes 121, 122 codes a specific sequence of square waves with a width 1 of 10 ns, with this sequence repeating cyclically. The sequence of square waves is defined so as to easily evaluate a time shift between its emission and its reception, as explained below. It has, for example, three square waves that follow each other, then, after 60 ns, only one square wave, then, after 40 ns, two square waves that follow each other, etc.

The emitted luminous signal s1 hits the obstacle 6 and yields the reflected luminous signal s2. The photodiodes 321 and 322 pick up the blue components of the reflected luminous signal s2 and ambient light, for example, sunlight, and send an electrical signal to an electronic control device 13, which amplifies it and sends it to the decoding means 38. The electronic control device 13 optionally comprises, in addition to an amplifier stage, a post-equalization stage.

The decoding means 38 count Nb the photons received, as a function of time t, by each of the photodiodes 321, 322, and comprise means 34 for thresholding the intensity of the luminous signal received by the photodiodes 321, 322 relative to the luminous intensity of sunlight. This thresholding corresponds to clipping the count signal Nb as a function of time t, beyond a number of photons corresponding to the luminous intensity of the blue component of sunlight, which yields a thresholded luminous signal s3. Indeed, with the blue component emitted by the diodes 121, 122 being more intense than the blue component of sunlight, such thresholding allows the component due to sunlight to be removed from the received electrical signal. Of course, in this case a thresholded luminous signal is actually an electrical or digital signal corresponding to the thresholding of the received luminous signal s2.

The decoding means 38 also comprises means 36 for correlating the thresholded luminous signal s3 with the luminous signal s1 sent by the diodes 121, 122. These correlation means 36 determine a time shift t between the thresholded luminous signal and the sent luminous signal s1, and transmit this time shift t to the obstacle detection means 40 of the lighting system 1. The obstacle detection means 40 convert this time shift t into a distance from an obstacle 6, and therefore allow this obstacle to be detected.

In order to allow the decoding means 38 to separate, in the analysis of the luminous signals received by the luminous device 26, the signals resulting from a reflection of a luminous signal emitted by the front left 22 and front right 24 lighting devices, the emission means of the lighting system 1 specific to the front left 22 and front right 24 lighting devices differ from those specific to the luminous device 26, in the used source of square wave signals.

Indeed, the emission means specific to the front left 22 and front right 24 lighting devices comprise, for each of these lighting devices, a square wave signal source and an electronic device for controlling the diodes of the lighting device 22, 24, in a similar manner to the square wave signal source 10 and the electronic control device 3. However, while the square wave signal source 10 emits a first sequence of square waves, the square wave signal sources of the lighting devices emit a second sequence of square waves different from that emitted by the square wave signal source 10. In other words, the sequence of square waves formed by this second sequence differs from the sequence of square waves formed by the first sequence, for example, the second sequence has 2 square waves that follow each other, then, after 80 ns, only one square wave, then, after 60 ns, three square waves that follow each other, etc.

The square wave signal sources of the lighting devices optionally emit this second sequence at a frequency different from the emission frequency of the square wave signal source 10. For example, the square wave signal source 10 emits at 50 MHz and the square wave signal sources of the lighting devices emit at 100 MHz.

Furthermore, the luminous signal emitted by the luminous device 26 preferably has less power than the luminous signal emitted by the lighting devices 22, 24, since the luminous device 26 is dedicated to obstacle detection in the area z only.

Of course, the invention is not limited to the examples that have just been described and numerous modifications can be made to these examples without departing from the scope of the invention.

What is claimed is:

1. A lighting system for a vehicle, comprising an optical assembly including a front left lighting device and a front right lighting device each able to project a lighting beam, means for emitting a high-frequency coded luminous signal outside the vehicle with photonic emitters, and a means for receiving such a luminous signal arriving from outside the vehicle with photonic receivers,
a luminous device intended to be arranged on the vehicle between the lighting devices, the luminous device includes at least one portion of the set of photonic emitters and at least one portion of the set of photonic receivers, and in that the lighting system includes obstacle detection means, and means for decoding a luminous signal received by one of the photonic receivers of the luminous device, able to provide at least one value representing a time shift between, on the one hand, the luminous signal received by the photonic receiver of the luminous device and, on the other hand, a luminous signal sent by at least one of the photonic emitters of the luminous device to the obstacle detection means.

2. The lighting system as claimed in claim 1, wherein the emission means includes means for coding a high-frequency signal intended to be transmitted by photonic emitters of the luminous device, at a frequency ranging between 5 and 200 MHz.

3. The lighting system as claimed in claim 1, wherein the luminous device is able to implement a display or signaling function.

4. The lighting system as claimed in claim 1, wherein the at least one portion of the set of photonic emitters of the luminous device is configured to emit wavelengths in the visible spectrum.

5. The lighting system as claimed in claim 1, wherein at least one of the lighting devices includes another portion of the set of photonic emitters of the emission means and another portion of the set of photonic receivers of the reception means.

6. The lighting system as claimed in claim 1, wherein the other portion of the set of photonic emitters of the emission means is of the same type as the at least one portion of the set of photonic emitters of the luminous device.

7. The lighting system as claimed in claim 1, wherein the other portion of the set of photonic emitters of the emission means is configured to emit wavelengths in the visible spectrum.

8. The lighting system as claimed in claim 1, wherein the decoding means are able to decode a luminous signal received by one of the photonic receivers of the lighting device, and to provide at least one value representing a time shift between the luminous signal received by the photonic receiver of the lighting device and a luminous signal sent by at least one of the photonic emitters of the lighting device to the obstacle detection means.

9. The lighting system as claimed in claim 1, wherein the emission means are configured to send the photonic emitters of the lighting device an electrical signal coding a first sequence of square waves, and to send the photonic emitters of the luminous device an electrical signal coding a second sequence of square waves.

10. The lighting system as claimed in claim 9, wherein the first sequence of square waves is different from the second sequence of square waves.

11. The lighting system as claimed in claim 9, wherein the first sequence of square waves is identical to the second sequence of square waves.

12. The lighting system as claimed in claim 9, wherein the electrical signal coding the first sequence of square waves has lower electrical power than the electrical power of the electrical signal coding the second sequence of square waves.

13. The lighting system as claimed in claim 9, wherein the first sequence of square waves is sent at a frequency different from a frequency for sending the second sequence of square waves.

14. The lighting system as claimed in claim 1, wherein the decoding means includes means for thresholding a luminous signal received by one of the photonic receivers of the lighting system, providing a thresholded luminous signal, and means for correlating the thresholded luminous signal with a luminous signal sent by at least one of the photonic emitters of the lighting system, with the correlation means providing a value representing a time shift between the thresholded luminous signal and the luminous signal sent by the photonic emitter of the lighting system, and wherein the obstacle detection means includes means for converting the representative value originating from the correlation means into a distance from an obstacle.

15. A vehicle comprising a lighting system, the lighting system includes an optical assembly including a front left lighting device and a front right lighting device each able to project a lighting beam, a means for emitting a high-frequency coded luminous signal outside the vehicle with photonic emitters, and a means for receiving such a luminous signal arriving from outside the vehicle with photonic receivers,
a luminous device intended to be arranged on the vehicle between the lighting devices, the luminous device includes at least one portion of the set of photonic emitters and at least one portion of the set of photonic receivers, and in that the lighting system includes obstacle detection means, and means for decoding a luminous signal received by one of the photonic receivers of the luminous device, able to provide at least one value representing a time shift between, on the one hand, the luminous signal received by the photonic receiver of the luminous device and, on the other hand, a luminous signal sent by at least one of the photonic emitters of the luminous device to the obstacle detection means, wherein the front left lighting device is arranged on a front left portion of the vehicle, the front right lighting device is arranged on a front right portion of the vehicle, and the luminous device is arranged on a front face of the vehicle between the front left lighting device and the front right lighting device.

16. The vehicle as claimed in claim 15, wherein an emission surface of the photonic emitters of the luminous device and a reception surface of the photonic receivers of the luminous device are fixedly mounted parallel to the front face of the vehicle.

17. The vehicle as claimed in claim 15, wherein the luminous device is arranged at least partially downwardly offset from the lighting devices.
